(19) United States
(12) Patent Application Publication
(10) Pub. No.: US 2001/0047964 A1
(43) Pub. Date: Dec. 6, 2001

(54) Method for treating liquid by creating a liquid cyclone photon interface

(76) Inventors: Thomas G. Matherly, Lompoc, CA (US); Dwain E. Morse, Santa Barbara, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/859,172

(22) Filed: May 16, 2001

Related U.S. Application Data
(60) Provisional application No. 60/208,347, filed on May 31, 2000.

(51) Int. Cl. C02F 1/48

(52) U.S. Cl. 210/748; 210/787

(57) ABSTRACT

A method for treating liquids includes the steps of directing liquid into a hydrocyclone to form a liquid vortex having an inner surface defining an evacuated central portion. Photon radiation is emitted into the evacuated central portion of the liquid vortex using a photon generator positioned at an upstream end of the hydrocyclone so as to separated from the liquid. The radiation may be modulated to increase the effectiveness of the treatment. Treating chemicals can also be added to the liquid to enhance the treatment effect. The photon radiation can include lightwaves or ultraviolet rays, microwave or millimeter wave radiation, or radio frequency radiation. The invention improves the treatment time per unit of volume liquid treated, as well as reducing the maintenance associated with such systems.

### RELATED APPLICATIONS

This application claims priority from Provisional Application No. 60/208,347, filed May 31, 2000.

### BACKGROUND OF THE INVENTION

The present invention generally relates to the treatment of contaminated fluids, such as water. More particularly, the present invention relates to an apparatus and method to allow photon stimulation of a liquid medium, water for instance, which allows a desirably uniform and complete irradiation of liquid molecules and suspended solids distributed in such a liquid volume.

It is well known by those skilled in the art that the irradiation of contaminated water using ultraviolet energy is an effective means of reducing biological contamination. Microbes have been shown to be reduced in viability as a result of direct and indirect actinic effects of photon energy.

It is further known by those skilled in the art that longer wavelength photons, those in the visible, infrared, and extending down into the radio frequencies, are capable of interacting with polar molecules such as water. These interactions cause vibrational, librational and rotational interactions at the atomic and molecular levels. These energetic effects are said to include the breaking and rearrangement of hydrogen bonding networks, changing the behavior of hydration and interfacial forces upon suspended solids and solid interfaces, and affecting the distribution of dissolved gas molecules.

The challenge in the energetic irradiation of water and other liquids is the means by which energy is delivered from the photon generating device into the liquid phase. For instance, ultraviolet energy is strongly absorbed by oxygen, and even more strongly absorbed by ozone, which itself may be a product of ultraviolet energy. Many solid materials that are optically transparent absorb a substantial fraction of ultraviolet energy passing through them as well. Water molecules absorb ultraviolet energy also.

While the absorption of ultraviolet energy by water and/or oxygen is desirable in some processes (e.g. as a means of generating radical species), it is sometimes desirable to expose distributed entities in the water to the ultraviolet energy as well. These distributed entities are often hydrated and surrounded by hydrogen bonds, and/or other absorptive structural elements in the solution. Accordingly, it would be desirable to generate sufficient translational disturbance and flow in the liquid phase to allow the constituents in the water to travel close to the photon interface where the photon flux density would be desirably high.

In addition to ultraviolet irradiation of water solutions, it is also often desirable to irradiate water solutions with lower energy photons. As previously described, the effects of such treatment can change water structural details. These changes can be manipulated to control the buildup of undesirable mineral scale layers, the fouling of membrane surfaces with either mineral scale or biological slime layers, and other undesirable effects.

Presently used treatment devices that employ ultraviolet energy to affect water are configured in a similar fashion. Ultraviolet lamp tubes are used as a source of lightwave photon energy. The tubes used are of various constructions (e.g. low pressure mercury vapor, medium pressure mercury vapor, short -arc, etc.). The lamps are placed inside a protective transparent tube. The tube is usually made of quartz because of its relatively low energy absorption in the ultraviolet spectrum. The purpose of the quartz tube is to protect the lamp and it's electrical interface from the water in which it is immersed while providing an optical “window” into the water. Water is then caused to flow around the protective tubes, and is subjected to U.V. irradiation.

There are many configurations of this family of devices. The variations are often “improvements” to maximize irradiation of the total volume of water and cleanliness of the protective tubes.

The problems with prior art U.V. water treaters are as follows:

1. Inefficient conversion of electrical power to effective U.V. energy.

2. Lamp replacement is difficult enough to require excessive system downtime.

3. The protective tube becomes coated with material that reduces transmission of target photons and so requires excessive manual cleaning.

4. Limited probability that all of the stream to be treated will receive the dose of photon energy necessary to have the desired effect.

5. Components reduce the amount of photon energy reaching the target constituents of the stream (e.g. protective tube, gas in the space between the lamp tube and the protective tube)

6. Concentration of the energies of the photon sources in few strong spectral bands (e.g. mercury vapor lines) while there is evidence that other frequencies may provide more useful results with some microorganisms.

What is needed then, is an apparatus and means to irradiate liquid stream constituents with the following attributes:

1. Delivery of maximum effective U.V. energy per KWH of electrical energy into the bulk water.

2. Shorter downtime to replace lamps.

3. Elimination of the need to clean protective “tube”.

4. A high probability that all of the stream to be treated will receive a useful dose of photon energy.

5. Reduction of components that attenuate photon energy.

6. Delivery of other frequencies may provide more useful results with some microorganisms.

The present invention fulfills these needs while providing related advantages.

### SUMMARY OF THE INVENTION

The liquid cyclone photon interface of the present invention provides a cost effective and improved means of treating liquid streams such as drinking water, domestic and industrial wastewater, and commercial liquid process streams. The invention uses a unique combination of mechanical and photon energy. The invention generally comprises a method for treating liquid comprising the steps of directing the liquid into hydrocylone to form a liquid vortex having an inner surface defining an evacuated central portion. Radiation is then emitted into the evacuated central portion of the liquid vortex to treat contaminants or affect liquid chemistry. Treating chemicals can also be added to the liquid before the liquid exits the hydrocyclone. When compared to the prior art, it provides higher energy efficiency in useful photons per kilowatt hour (KWH) of consumed electrical energy as well as improved distribution of photons into the bulk water. As a result, the treatment time per unit volume is improved.

General embodiment: To realize the advantages described above, the apparatus in its general form comprises a system operating from a pressurized source of liquid influent. The influent then accelerates into the conical section of a hydrocyclone tangentially. A vortex forms inside the hydrocyclone body and operates as an eductor such that a conical evacuated phase is surrounded by an energetic liquid vortex. Photon energy enters the vacuum vortex at the upstream end of the hydrocyclone, fully irradiating the liquid/vacuum interface axial to the apparatus. The treated liquid exits the apparatus at the submerged downstream end of the hydrocyclone, which end is submerged in an effluent tank.

Lightwave embodiment: In another form, the previously described liquid/vacuum vortex is irradiated using a generator of photons with frequencies from ultraviolet to infrared, inclusive (i.e. lightwave). This photon source couples to the liquid/vacuum interface, which interface then behaves as an absorptive optical waveguide.

Ultraviolet Embodiment: In another form, the previously described liquid/vacuum vortex is irradiated using a generator of photons in the ultraviolet portion of the spectrum. Examples of generators that could be used in this embodiment are xenon lamps, useful because many have a relatively constant level output in wavelengths between approximately 200 and 1100 nanometers, and mercury vapor lamps, which have output focused in a narrower range of frequencies (147 to 254 nanometers). The spectral output of the xenon source includes infrared, visible, and importantly, a substantial spectral output in the ultraviolet, extending to wavelengths below 200 nm. This photon source couples to the liquid/vacuum interface, which interface then behaves as an absorptive optical waveguide.

Microwave embodiment: In yet another form, the previously described liquid/vacuum vortex is irradiated specifically from source of microwave or millimeter wavelength photons. At the desired frequency, the photon source is coupled to the liquid/vacuum interface. The interface then behaves as an absorptive microwave or millimeter wave waveguide.

Radio frequency embodiment: In still another form, the previously described liquid/vacuum vortex is irradiated specifically from a radio frequency voltage probe. At the desired frequency, the liquid/vacuum interface is coupled to the radio frequency voltage probe such that the liquid interface is subjected to high amplitude radio frequency potentials.

Modulated embodiment: In a further form, the previously described photon generating devices are connected to a modulating electrical power supply, such that the photon flux incident at the liquid/vacuum interface may be subjected to lower frequency modulating energy generally in a range of 1 hz to 1 Mhz.

Other features and advantages of the present invention will be apparent from the following detailed description, when read in conjunction with the accompanying drawings.

### BRIEF DESCRIPTION OF THE DRAWINGS

The accompanying drawings illustrate the invention. In such drawings:

FIG. 1 is a schematic view of a fluid treatment system utilizing the liquid cyclone photon interface of the present invention;

FIG. 2 is a cross-section view of a liquid cyclone photon interface embodying the invention wherein lightwave energy is utilized to irradiate a fluidized solution;

FIG. 3 is a sectional view similar to FIG. 2, illustrating another embodiment of the liquid cyclone photon interface wherein the fluidized solution is irradiated with microwave or millimeter wavelength photon energy;

FIG. 4 illustrates a third embodiment of the liquid cyclone photon interface of the present invention, wherein the fluidized solution is irradiated with low frequency through ultrahigh frequency energy source; and

FIG. 5 is a schematic representation illustrating the manner in which the photon source of FIGS. 2-4 is powered by an electrical power supply.

### DETAILED DESCRIPTION OF THE PREFERRED EMBODIMENTS

General Embodiment:

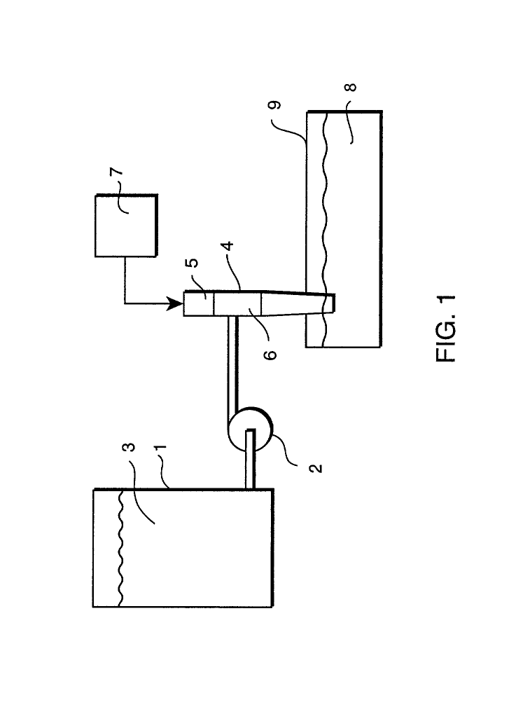

Referring to FIG. 1, the general embodiment of a liquid cyclone photon interface is described. It discloses the liquid cyclone photon interface configured into an operational water treatment system.

An influent source tank 1, containing contaminated liquid 3 (usually water), is connected to communicate with the suction of a pump 2. The pump 2 discharge line communicates with a liquid cyclone photon interface apparatus 4. The liquid cyclone photon interface apparatus contains a liquid inlet port, a hydrocyclone 6, and a photon source 5. The photon source 5 is mounted at the upstream end of the hydrocyclone 6 and is connected to an electrical power supply 7. Photon energy radiates from this source into the vacuum 17/liquid 16 vortex. The hydrocyclone portion 6 of the liquid cyclone photon interface 4 discharges the treated liquid 8 into effluent tank 9. This liquid will have been desirably modified, e.g. microbial contaminants reduced. The level of effluent in tank 9 is maintained such that the discharge port of hydrocyclone 6 is submerged.

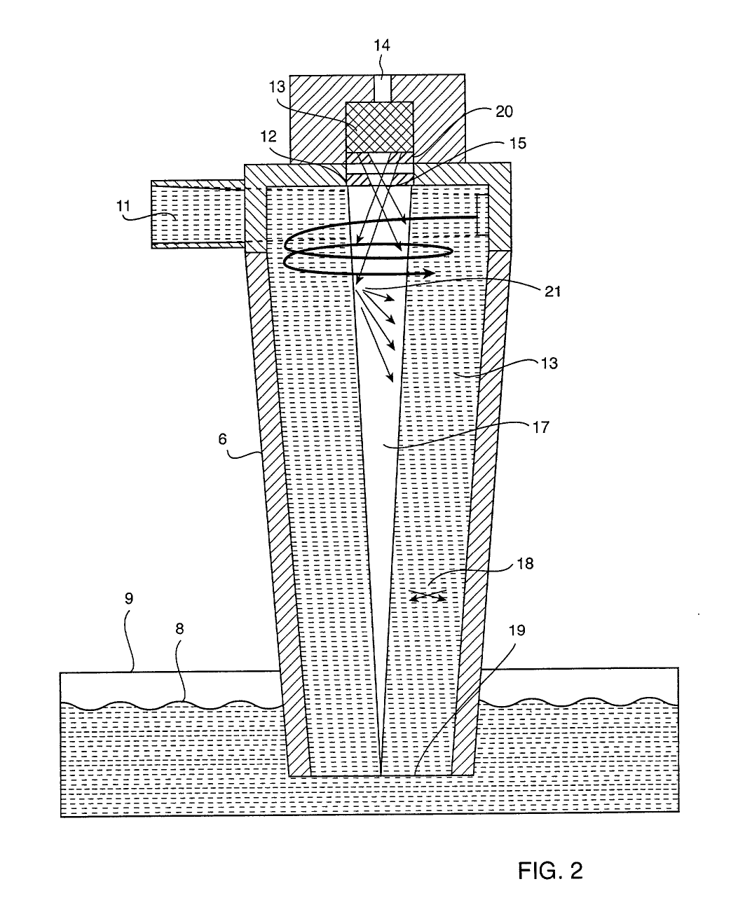

Referring now to FIG. 2, the contaminated liquid enters the hydrocyclone 6 as a stream. A portion of the body of the hydrocyclone 6 is of a truncated conical form. The upstream end of the hydrocyclone 6 is not open to atmosphere. The contaminated liquid 3 is accelerated into the top portion of the cyclone at 11 and follows a helical path in a decreasing radius toward the outlet 19 at the downstream end of the hydrocyclone 6. The liquid vortex 16 that forms in the cyclone 6 diminishes in area towards the outlet. Because the liquid velocity in the hydrocyclone is intentionally high, the cyclone acts as an eductor and a vacuum vortex 17 forms inside the liquid vortex 16. Inside the vacuum vortex 17, the relative pressure can drop to less than 0.5 PSI absolute.

In the liquid cyclone 6, extreme internal turbulent vortices 18 form at the microscopic level. As a result of these turbulent energies, the statistical probability of any microscopic volume of the bulk water translating near the inner vortex surface while traveling through the hydrocyclone 6 is high.

At the upstream end of the hydrocyclone 6, a photon generator is mounted. Energy radiated from this generator strikes the inside of the vacuum 17/liquid 16 vortex.

Because the water/vacuum interface is in a constant vortex flux, the photon energy 21 that strikes the water interface is either absorbed, reflected or scattered, depending upon the instantaneous microscopic angularity of the surface. The liquid vortex thus absorbs the photons being distributed along the vortex 16. The vortex 16 becomes an absorptive light waveguide, the photons being distributed and absorbed all along the vortex 16. As mentioned previously, the statistical probability of any microscopic volume of water molecules in the bulk flow translating near the liquid/vacuum vortex is high. In that the photon energy travels through a near vacuum, the attenuation of desirable photon energy is minimized.

Acetic acid (and other substances that cause the same biological effect) can be added to contaminated liquid 3 or to the liquid vortex 16. For certain microbes, this in combination with the photon energy causes changes in the assimilation of food and results in death of the microbes.

As described, the apparatus out-performs prior art devices, in that it overcomes or minimizes the previously listed limitations of the prior art. In summary:

1. The photon energy is directed to the stream with minimum path loss.

2. The lamp is positioned to be easily replaceable.

3. Since the water never touches the lamp window, and the light path is through near vacuum, cleaning is unnecessary.

4. The probability that all of the stream bulk will be irradiated is high.

5. The vacuum path guarantees minimum attenuation of optical energy.

Lightwave Embodiment:

Referring to FIG. 2, a second embodiment of a liquid cyclone photon interface is described. This embodiment is the same as the General Embodiment, except that the photon generator emits lightwave photons, which are those in the range of frequencies between ultraviolet and infrared, inclusive. At the upstream end of the hydrocyclone 6, an aperture plate 12 is mounted. This plate ensures that an evacuated area 20 on the other side of the aperture plate 12 will remain free of water. Above the aperture plate 12, inside the evacuated area 20, is a lamp 13. The lamp 13 is a high output, broad spectrum source of lightwave radiation. The lamp 13 has a single window that is transmissive to optical energy in the range of approximately 100 to 1100 nanometers. This lamp 13 has an elliptical internal reflector and provides a focused cone of light. The focal conjugate 15 of the lamp 13 is placed at the aperture plate 12. Thus, energy radiated from this lamp emanates in a downward facing direction, striking the inside of the vacuum 17/liquid 16 vortex at an acute angle.

Ultraviolet Embodiment:

Still referring to FIG. 2, a third embodiment of a liquid cyclone photon interface is described. This embodiment is the same as the Lightwave Embodiment, except that the lamp 13 is one that emits photons with frequencies in the ultraviolet portion of the spectrum. For example, a xenon or mercury vapor lamp may be used.

If a xenon lamp is used, a single crystal sapphire window is used by the photon generator. This lamp is a commercially available device. One such lamp is manufactured by EG&G Optoelectronics under the trademark of CERMAX®. These lamps are typically used in fiber-optic illuminators, in microscopy, spectroscopy etc. The devices are available with power ratings from 75 watts to more than 1000 watts. Equipped with this lamp type, the following advantage is added to the list of advantages of the General Embodiment:

6. The xenon source lamp used in this embodiment covers the entire useful U.V. spectrum, so that more species of microbe may be susceptible.

In one specific implementation, the hydrocyclone 6 cylinder is constructed of 0.06 inch thick stainless steel. The entrance diameter of the conical section is four inches in diameter. A tangential liquid inlet port 11 is installed, the inlet port being one inch wide by two inches high. The inlet port 11 communicates with a pump discharge port, the pump 2 being a centrifugal type, operated at a hydrocyclone inlet port 11 pressure of 75 psi, and a commensurate liquid flow rate of approximately 150 gallons per minute (gpm). The pump suction communicates with contaminated water 3, the source of contaminated water 3 being a liquid influent tank 1.

The hydrocyclone conical body section has a truncated conical form 48 inches in length that terminates in a hydrocyclone liquid outlet 19, the outlet being two inches in diameter. The liquid hydrocyclone outlet 19 is immersed in effluent liquid to a depth of approximately twelve inches. The effluent liquid 8 is contained in an effluent tank 9.

At the up-stream end of the hydrocyclone 6, a two inch diameter port communicates with an aperture plate 12. The aperture plate 12 is made of stainless steel and oriented perpendicular to the long axis of the hydrocyclone. The aperture itself is round, approximately ¾ inch in diameter, and knife edged at a 30° angle all around. In an upstream direction from the aperture plate, at a distance of approx 1.4 inches, the window of a xenon lamp 13 is placed, the lamp window being perpendicular to the long axis of the hydrocyclone 6. This lamp is preferably an ILC® (EGG Inc®) model EX1000-13UV. The lamp window is operated in the evacuated area 20, and the lamp body is thermally coupled to the hydrocylone 6 metallic body. This thermal coupling is for the purpose of cooling the lamp in operation. The lamp is electrically connected to the electrical power supply. The apparatus described above may be constructed using other materials and dimensions to accommodate system requirements of flow and irradiation without departing from the uniqueness of invention.

In operation, the contaminated water is analyzed to characterize the nature and amount of contamination, using BOD, COD, plate count, or other method well known in the art. The liquid influent tank is supplied with contaminated water. The pump is turned on, and the pump speed is adjusted to generate liquid pressure at the hydrocyclone entrance commensurate with the desired flow rate and formation of the liquid 16 and vacuum 17 vortices. After the liquid vortex 16 is established, the xenon lamp 13 is energized. This sequence ensures that the xenon lamp 13 is properly cooled, and that the liquid cyclone photon interface is not damaged through heat buildup. The xenon photon source 13 is then energized. The contaminated water 3 is now being irradiated by the photon source, and the contaminants are being destroyed or altered due to the photon flux into the liquid vortex. The effluent liquid 8 passes into the effluent tank. The effluent liquid 8 is analyzed to characterize the extent of the kill efficiency. The treated water is then sent to the desired process or disposed of.

In this xenon lightwave form, a primary usefulness of the apparatus is the destruction of microbiological entities, such as bacteria, fungal spores, oocysts, viruses, etc. This use finds application in the sterilization and/or disinfection of potable, wastewater, or industrial process waters. In addition, it can reduce biofouling of membrane filtration systems. The apparatus has other uses, such as induced photochemical processes used in chemical manufacturing, pharmaceutical manufacturing, ultra purification of water for semiconductor manufacturing, etc. While the direct actinic destruction by modification of cell DNA is one mechanism exploited by the apparatus, secondary processes relying upon radicalization of water and dissolved gasses which then attack undesirable suspended species are also a desirable feature.

Microwave Embodiment:

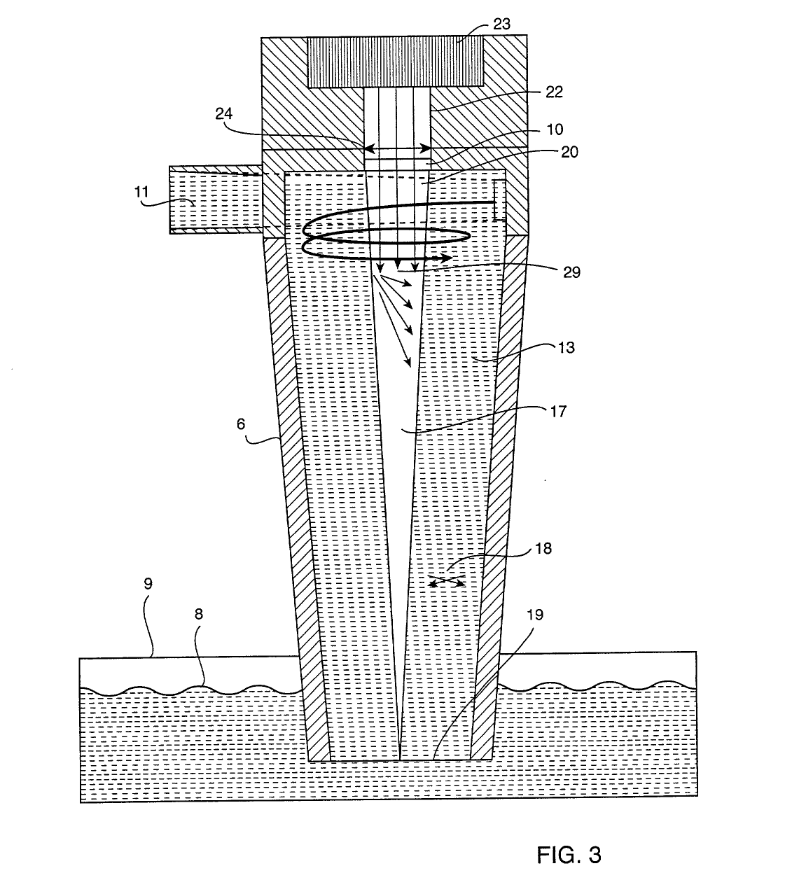

Referring now to FIG. 3, a fourth embodiment of a liquid cyclone photon interface is described. This embodiment is the same as the General Embodiment except that it is directed to the microwave/millimeter wave irradiation of the influent liquid.

The hydrocyclone 6 portion of the invention as described above by the general form of the invention is part of this embodiment. Thus, the vacuum inner vortex 17, the turbulence of the internal vortices, and the high probability of any microscopic volume being exposed on the inner surface of the liquid vortex 16 are present.

At the upstream end of the hydrocyclone 6, a microwave-transmissive window 10 is mounted. The area above the window communicates with the waveguide horn 22 of a magnetron 23 or other microwave power source. This window 10 ensures that the area beyond the upstream end will remain free of water. The waveguide interface is designed to be coaxial with and of the same diameter as the liquid vortex 16 which begins in the cyclone entry area. Thus, the energy radiated from this microwave source emanates through the window 10, striking the inside of the vacuum 17/liquid 16 vortex at an acute angle. The minimum frequency at which the device is useful is defined by the vortex entrance diameter 24. At diameters below a certain diameter, the interface would act as a “waveguide below cutoff”. This would undesirably attenuate the transmission of microwave energy into the vortex.

Because the liquid 16/vacuum 17 interface is in a constant vortex flux, the microwave energy 29 that strikes the water interface as it travels down the “waveguide” formed by the liquid 16/vacuum 17 interface is either absorbed, reflected or scattered, depending upon the instantaneous microscopic angularity of the surface. The vortex 16 becomes an absorptive microwave waveguide, the microwave photons being distributed and absorbed all along the vortex.

As a result of the geometry of the liquid 16/microwave 29 interface, evanescent electric fields at the microwave frequency 29 are thus imposed upon the liquid phase, causing desirable modulation of any polar molecules (e.g. water), causing vibrations, librations, and/or rotations to break or otherwise desirably alter the hydrogen bonding networks in the liquid. Influences are thus exerted upon polar/nonpolar interfaces such as dissolved gas volumes, affecting the distribution and attachment of gas volumes to distributed hydrophobic contaminants. Additional desirable effects may include the ability to cause the electroporation of biological contaminants, allowing the cells to absorb chemical additives, modification of surface interfacial behavior to control downstream scale formation and membrane fouling, etc.

In the microwave embodiment, the apparatus described in the xenon lamp example is modified as follows. The xenon lamp 13 is replaced with a rigid waveguide section 22 that meets the up-stream cyclone entrance area in the same orientation. In place of the aperture plate 12, a microwave-transmissive solid window 10 is installed. Above this window 10, the xenon lamp 13 is replaced with a waveguide horn 22 assembly. Feeding this waveguide horn 22 assembly is a magnetron 23 assembly. This magnetron is preferably a generic 2450 Mhz microwave oven typ., (reliable, commonly available device). This magnetron 23 is rated for 750 watts continuous pulsed output. The magnetron 23 is electrically connected to an electrical power supply 7. This apparatus may also be constructed using other materials and dimensions to accommodate system requirements of flow and irradiation without departing from the uniqueness of invention.

The operating sequence of the second system is the same as for the xenon example above except that: The photon source energized is the magnetron microwave source 23. The other difference from the xenon example is that a second reason exists for establishing the liquid vortex 16 before energizing the photon source. It ensures that the magnetron microwave source waveguide is properly matched to the liquid vortex diameter, so that energy transfer from the magnetron to the liquid vortex 16 is maximized.

In this microwave example, the apparatus can modify colloidal interfacial forces between particles suspended in the contaminated influent and solid surfaces encountered in downstream environments. Additionally, when the microwave energy 29 is modulated with a lower frequency signal, it can cause electroporation of suspended microbes in the liquid stream, allowing the infusion of chemistry into the biological cells. Thus, useful effects include both biological effects and colloidal effects, desirable in the cleaning or polishing of both potable and waste waters, as well as promoting protection of interfacial surfaces in liquid handling apparatus and membrane filtration systems.

Radio Frequency Embodiment:

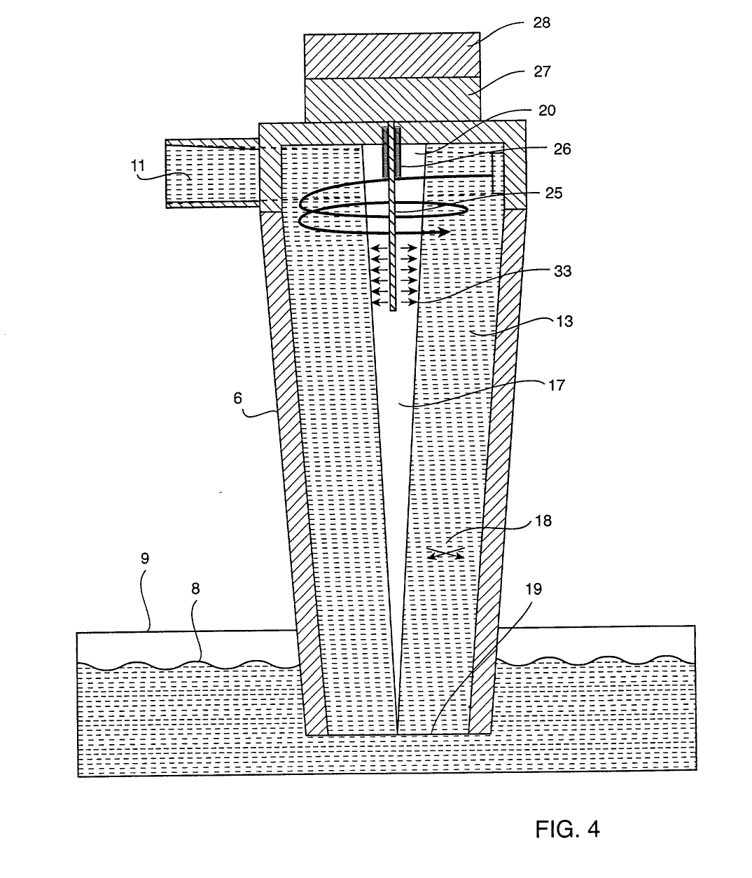

Referring now to FIG. 4, a fifth embodiment of a liquid cyclone photon interface is described. This embodiment is the same as the general embodiment except that it is directed to the low-frequency-through-ultra-high-frequency wave irradiation of a solution.

Desirable effects resulting from radio frequency stimulation of solutions have been observed at frequencies well below the microwave region. This embodiment provides an effective energy interface for radio frequency energy in a range of frequencies where the “waveguide” approach described in the lightwave embodiment becomes impractical because the waveguide aperture dimension becomes impractically large.

At the upstream end of the cyclone 6, a radio frequency voltage probe 25 is inserted into the vacuum vortex 17 area. This probe 25 is connected to a radio frequency generator 28, and the output of the generator is impedance matched 27 to the voltage probe 25 such that the probe becomes the distal portion of a quarter wavelength line section. Thus configured, a radio frequency voltage maxima will exist at the distal end of the voltage probe element.

This probe 25 is set on the radial axis of the liquid hydrocyclone, extending down into the evacuated vortex area 17. Situated in this manner, the probe 25 does not contact the liquid 16, but rather is positioned such that the electric field surrounding the probe 25 extends outward into the liquid vortex 16, subjecting the liquid vortex inner surface to high radio frequency potentials. The probe assembly is surrounded at it's upper extreme by a non-conductive electrical insulating sleeve 26, said sleeve 26 protecting said probe from liquid contact from the liquid cyclone inlet port 11.

The radio frequency voltage probe 25 may form a relatively short section of the overall resonant length of a quarter wavelength line section, or the probe 25 may be as much as a quarter wavelength long, or the probe 25 may be multiple quarter wavelengths long dependent on operating frequency and desired effect. In the case of the voltage probe 25 being a fraction of a quarter wave in length (non-resonant at the operating frequency), the impedance matching network 27 may comprise a coaxial line section, a strip line, a helical resonator, or it may be constructed from “lumped” circuit elements (i.e. discrete inductors and capacitors). The desirable operating condition is that the circuit 27 be tuned to resonance, thus ensuring maximum radio frequency potential at the distal end of the voltage probe 25.

With the above mentioned configuration, the radio frequency probe 25 defines an oscillating radio frequency voltage source, operating in a near vacuum 17, surrounded by a liquid vortex 16. Thus, the liquid 16, which is in continuous translational flux, is desirably subjected to high-energy radio frequency voltage fluctuations. The complex permittivity of the liquid 16 is stimulated by the voltage flux, causing desirable modification in the liquid 16 which may include breaking and re-arrangement of hydrogen bonds, displacement of polar/nonpolar volumes of liquid and/or dissolved gas, changes in surface interfacial attractive or repulsive force relationships of suspended solids, and other desirable effects.

In the radio frequency embodiment, the apparatus described in the xenon lamp example is modified to replace the aperture plate 12 with a solid up-stream wall 121. Penetrating the wall 125 is an electrical insulating sleeve 26 through which is inserted a radio frequency voltage probe 25. The radio frequency voltage probe 25 is connected to a helical resonator configured as an impedance transformer and impedance matching network 27. The radio frequency impedance matching network 27 is driven by a radio frequency generator 28. The radio frequency generator is electrically connected to an electrical power supply 7. The apparatus described above may be constructed using other materials, impedance matching networks, and dimensions to accommodate system requirements of flow and irradiation without departing from the uniqueness of invention.

The operating sequence of the radio frequency example is as for the xenon example above except that: The photon source is the radio frequency voltage probe and driver circuits. It is necessary to establish the liquid vortex before energizing the photon source. This is for two reasons. One is the matching of radio frequency voltage probe to the liquid vortex 16 diameter for maximum energy transfer from the radio frequency generator 28. The other is that the radio frequency generator circuitry may otherwise be damaged by heating caused by reflected radio frequency energy.

In this radio frequency example, the apparatus can modify colloidal interfacial forces between particles suspended in the contaminated influent and solid surfaces encountered in downstream environments. Additionally, when the radio frequency energy is modulated with a lower frequency signal, it can cause electroporation of suspended microbes in the liquid stream, allowing the infusion of chemistry into the biological cells. Thus, useful effects include both biological effects and colloidal effects, desirable in the cleaning or polishing of both potable and waste waters, as well as promoting protection of interfacial surfaces in liquid handling apparatus and membrane filtration systems.

Modulated Embodiment:

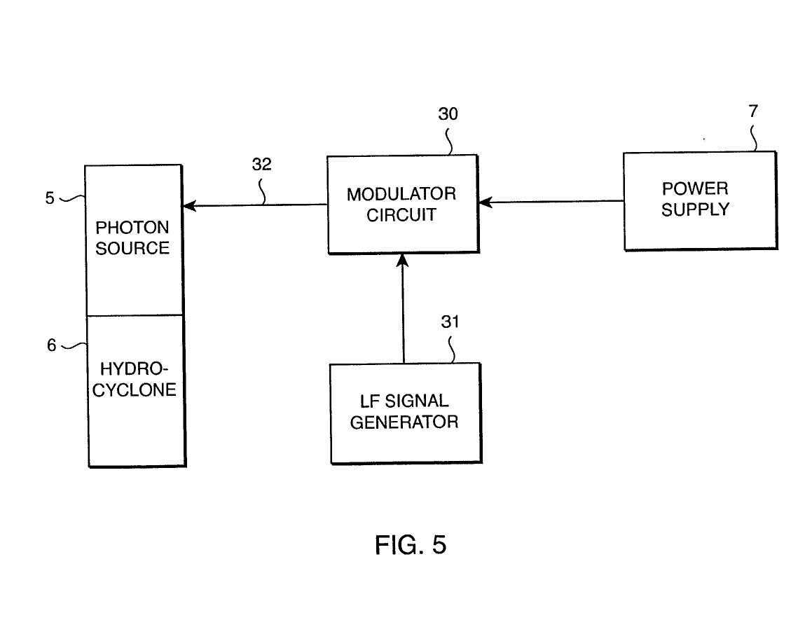

Referring now to FIG. 5, a sixth embodiment of a liquid cyclone photon interface is described. This embodiment is the same as the general embodiment except that it is directed to the modulation of the photon sources 5 described in the foregoing embodiments to enhance system performance.

It is well known to those skilled in the art that microbiological entities, e.g. cells, may be desirably affected by the generation of an oscillating electrical field proximal to such biological entities. For instance, it is common practice in the microbiological field to subject cellular material to electric field perturbations. The fields are generated between electrodes immersed in a solution containing said cells.

The effect of this process is termed “electroporation”. The cells, being subjected to localized electric field variations, spontaneously become permeable, allowing dispersed or dissolved chemistry or genetic material to traverse the otherwise impermeable cell wall. Thus it is possible in some cases to affect the genetic makeup of the cell, or in other cases to “inject” the cell with biocidal chemistry.

The electroporative process is stimulated at relatively low frequencies, typically in the range from 1 thru 10⁶ hz. At the same time, relatively high potentials are required when electrodes are used, since the potential gradient proximal to a cell is small due to the microscopic space occupied by the cell, relative to the relatively enormous space defined by the electrode spacing.

As previously described, the effects of electromagnetic energy interacting with solvent and solute molecules may include vibrational, librational, or rotational moments acting in opposition to the normal motional behavior of molecular and atomic constituents in the medium.

These resonant interactions with the solution are said to be capable of altering the structural details of the solution at the level of hydrogen bonds and long range weak electric field forces such as van der Waals forces.

By periodically interrupting the photon flux impinging upon the solution, it is thus possible to create a second type of motional disturbance in the solution, namely, a lower energy acceleration/deceleration of the groups effected by the higher energy photon flux, but at the rate of the lower energy modulating signal.

This modulation of the higher energy photon flux with a lower energy modulating function is thus capable of inducing lower frequency motional energies in the solution, by virtue of the periodic relaxation of the high energy photon flux, which in turn produce desirable localized lower frequency electrical field oscillations. It is this distributed lower frequency electric field perturbation which locally influences the biological cells, and being of sufficient electric field amplitude, causes the electroporative process to proceed.

Referring to FIG. 5, a photon source 5 (e.g. UV lamp, microwave source, LF-UHF generator) is powered by an electrical power supply 7. The circuit between the electrical power supply 7 and the photon source 5 includes an electrical modulator circuit 30. The electrical modulator circuit 30 communicates with a low frequency signal generator 31.

The photon source 5 is configured with the hydrocyclone apparatus 6, as shown in FIGS. 2 through 4, and the photon/cyclone system operation is as described in those embodiments.

In operation, the photon source 5 is powered by the electrical power supply 7. The electrical modulator circuit 30 is configured to control the photon flux output of the photon source, by modulating the powerform 32 applied to the photon source, preferably over a range of 0-100% photon/RF output. The low frequency signal generator 31 is adjusted to the desired frequency, preferably in a range between 1 thru 10⁶ Hz. The modulation may be of any desired waveform (square, triangle sine, etc.) and thus, the low frequency signal generator is set to the preferred waveform for most efficacious treatment. The percentage and range of modulation is set to the preferred range of level for most efficacious treatment. The apparatus operates in conjunction with the liquid cyclone photon interface to provide desirable effects, such as electroporation of distributed biological cells.

While the apparatus is directed to the electroporative process, it is understood that other useful effects of the apparatus such as surface chemistry effects, are within the scope of the invention.

The operating sequence of the modulated system is the same as the above examples. However, adjustment is made to the modulating circuitry of the flow frequency signal generator that is part of the modulation embodiment. This causes a low frequency modulation of the high energy photon source The modulating frequency and amplitude are set to a value known to cause cell wall poration of biotia in the liquid stream.

Although several embodiments have been described in detail for purposes of illustration, various modifications may be made without departing from the scope and spirit of the invention. Accordingly, the invention is not to be limited, except as by the appended claims.

What is claimed is:

1. A method for treating liquid, comprising the steps of:
directing the liquid into a hydrocyclone to form a liquid vortex having an inner surface defining an evacuated central portion; and
emitting radiation into the evacuated central portion of the liquid vortex.

2. The method of claim 1, including the step of adding treating chemicals to the liquid.

3. The method of claim 2, wherein the treating chemicals are added to the liquid before the liquid exits the hydrocyclone.

4. The method of claim 1, wherein the emitting step includes the step of modulating the radiation.

5. The method of claim 4, wherein the radiation is modulated at a frequency range between 1 hz to 1 Mhz.

6. The method of claim 1, wherein the emitting step comprises emitting photons into the liquid vortex using a photon generator.

7. The method of claim 1, wherein the emitting step comprises emitting light waves using a lamp.

8. The method of claim 7, wherein the light waves comprise ultraviolet rays.

9. The method of claim 7, wherein the lamp is positioned at an upstream end of the hydrocyclone and separated from the liquid vortex by a barrier.

10. The method of claim 7, including the step of focusing the light waves into a cone of light using a reflector.

11. The method of claim 1, wherein the emitting step comprises emitting microwave wave radiation into the liquid vortex.

12. The method of claim 1, wherein the emitting step comprises emitting millimeter wave radiation into the liquid vortex.

13. The method of claim 1, wherein the emitting step comprises emitting radio frequency waves into the liquid vortex.

14. The method of claim 13, wherein the radio waves are emitted using a radio frequency generator probe inserted into the evacuated central portion and operably connected to a radio frequency generator separated from the fluid vortex by a barrier.

15. A method for treating liquid, comprising the steps of:
directing the liquid into a hydrocyclone to form a liquid vortex having an inner surface defining an evacuated central portion; and
emitting photon radiation into the evacuated central portion of the liquid vortex using a photon generator positioned at an upstream end of the hydrocyclone so as to be separated from the liquid.

16. The method of claim 15, including the step of adding treating chemicals to the liquid before the liquid exits the hydrocyclone.

17. The method of claim 15, wherein the emitting step includes the step of modulating the radiation between a frequency range of 1 hz to 1 Mhz.

18. The method of claim 15, wherein the emitting step comprises emitting light waves using a lamp positioned at an upstream end of the hydrocyclone and separated from the liquid vortex by a barrier.

19. The method of claim 18, wherein the light waves comprise ultraviolet rays.

20. The method of claim 18, including the step of focusing the light waves into a cone of light using a reflector.

21. The method of claim 15, wherein the emitting step comprises emitting microwave wave radiation into the liquid vortex.

22. The method of claim 15, wherein the emitting step comprises emitting millimeter wave radiation into the liquid vortex.

23. The method of claim 15, wherein the emitting step comprises emitting radio frequency waves into the liquid vortex using a radio frequency generator probe inserted into the evacuated central portion and operably connected to a radio frequency generator separated from the fluid vortex by a barrier.

24. A method for treating liquid, comprising the steps of:
directing the liquid into a hydrocyclone to form a liquid vortex having an inner surface defining an evacuated central portion;
adding treating chemicals to the liquid before the liquid exits the hydrocyclone;
emitting photon radiation into the evacuated central portion of the liquid vortex using a photon generator positioned at an upstream end of the hydrocyclone so as to be separated from the liquid; and
modulating the radiation between a frequency range of 1 hz to 1 Mhz.

25. The method of claim 24, wherein the emitting step comprises emitting light waves using a lamp positioned at an upstream end of the hydrocyclone and separated from the liquid vortex by a barrier.

26. The method of claim 25, wherein the light waves comprise ultraviolet rays.

27. The method of claim 25, including the step of focusing the light waves into a cone of light using a reflector.

28. The method of claim 24, wherein the emitting step comprises emitting microwave wave radiation into the liquid vortex.

29. The method of claim 24, wherein the emitting step comprises emitting millimeter wave radiation into the liquid vortex.

30. The method of claim 24, wherein the emitting step comprises emitting radio frequency waves into the liquid vortex using a radio frequency generator probe inserted into the evacuated central portion and operably connected to a radio frequency generator separated from the fluid vortex by a barrier.
